(19) United States
(12) Patent Application Publication
(10) Pub. No.: US 2001/0056358 A1
(43) Pub. Date: Dec. 27, 2001

(54) Method and apparatus for providing medication administration warnings

(75) Inventors: Donna B. Dulong, Del Mar, CA (US); Steven R. Wehba, Carlsbad, CA (US); Douglas W. Comer, Oceanside, CA (US); Joanne S. Stark, San Diego, CA (US); Michael A. Kurtz, San Diego, CA (US); Barbara Trohimovich, San Diego, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: BRIDGE MEDICAL, INC.,

(21) Appl. No.: 09/815,478

(22) Filed: Mar. 23, 2001

Related U.S. Application Data
(60) Provisional application No. 60/191,955, filed on Mar. 24, 2000.

(51) Int. Cl. G06F 17/60

(52) U.S. Cl. 705/2

(57) ABSTRACT

A method, apparatus, and system for preventing medication errors by providing warnings at the time of medication administration. A user/administrator of medication and a patient are identified to the system. Once the patient is identified, a graphical user interface (GUI) listing available medications for that patient is displayed. The user selects a medication for administration from the GUI. One or more compliance rules are associated with one or more medications. Each compliance rule provides the text for a comment or warning to be displayed upon the occurrence of a specified condition. The condition may be based on an attribute of the medication or patient such as the name of the medication, allergies of the patient, etc. If a condition is satisfied, the comment/warning in the compliance rule associated with the medication is displayed to the user. If the user opts to continue with the administration of the medication, the medication is added to a confirmation list where the user administers the medication and may enter additional information regarding the administration (e.g., time of administration, notes, etc.). The compliance rules may be invoked to display a comment/warning regarding the traditional five patient rights—right patient, right medication, right dose, right route and right time. Additionally, the compliance rules may be invoked to display a comment/warning regarding many additional causes of medication errors. Such rules may include look-alike medications, sound-alike medications, physical act requirements, dosage requirements, monitor/health equipment requirements, route requirements, dilution requirements, test requirements, and lethal/toxic substance warnings.

### CROSS-REFERENCE TO RELATED APPLICATIONS

This application claims the benefit under 35 U.S.C. §119(e) of U.S. provisional application Ser. No. 60/191,955, entitled “SYSTEM AND METHOD FOR AUTOMATING MEDICATION ERROR DETECTION AND PREVENTION,” filed on Mar. 24, 2000, by Donna B. Dulong, et. al., attorney's docket number 136.2USP1, which application is incorporated by reference herein.

This application is related to the following co-pending and commonly-assigned patent application, which application is incorporated by reference herein:

U.S. patent application Ser. No. xx/xxx,xxx, entitled “METHOD AND APPARATUS FOR DISPLAYING MEDICATION INFORMATION”, by Donna B. Dulong et. al., Attorney Docket No. 136.2USU1, filed on the same date herewith.

### BACKGROUND OF THE INVENTION

1. Field of the Invention

The present invention relates generally to the prevention of errors in medication administration, and in particular, to a method, apparatus, system, and article of manufacture for providing medication administration warnings and comments.

2. Description of the Related Art

The proliferation of new drugs and increasing complexity of drug therapy has dramatically increased the incidence of medication errors and adverse drug events in hospitals. With the aging of the population, hospitals are treating more elderly and acutely ill patients whose ability to tolerate medication errors is compromised. At the same time, economic pressure from managed care and reduced reimbursement rates from public and private payors have caused hospitals to increase the patient/nurse ratio.

The process for administering drugs to patients has changed little in the past two decades. The process typically relies on verbal and written communication and involves several different clinicians from various areas within a hospital. Medication errors occur at every stage of the medication use process—in physician prescribing, order transcription, drug preparation, drug dispensing, and in administration to the patient. Existing information systems and automated drug distribution systems only incidentally address the problem of medication errors.

Several recent studies have documented the alarming rate of medication errors and adverse drug reactions in hospitals and their resulting deaths and related costs. Some of the findings are as follows:

6.5% of patients will experience a potentially serious error while hospitalized

over $4.0 billion in additional hospital costs are caused by medication errors and adverse drug events

Recently, the awareness of the high level of medication errors within hospitals has increased significantly and many leading hospitals in the United States have experienced highly publicized cases related to catastrophic medical errors. Lawsuits associated with medication errors have proliferated. In addition to the legal costs, hospitals' institutional reputations may be at risk if there is a highly publicized patient death due to medication error.

In response to the growing risks of medication errors, leading hospitals have developed initiatives to focus on the issue. In addition, professional associations representing nurses, hospital pharmacists, and physicians have identified medication errors as a major issue. The Health Care Finance Administration (HCFA) has discussed regulations that would exclude hospitals with high rates of medication error from reimbursement under the Medicare program. As a result, many constituencies are seeking a standard of care within hospitals to address the problem of medication errors and adverse drug events. For example, the Institute for Safe Medication Practices (ISMP) is a nonprofit organization that works closely with healthcare practitioners and institutions, regulatory agencies, professional organizations and the pharmaceutical industry to provide education about adverse drug events and their prevention. ISMP also releases “alerts” on a periodic basis that provides information relating to new medication errors or practices that hospitals, doctors, pharmacists, etc. should be aware of.

One of the last chances to prevent a medication error occurs when the medication is administered to a patient. Accordingly, numerous medication errors result at the time of medication administration. Such errors occur based on a variety of factors. For example, medication errors often occur as a result of a violation of one or more of a patient's “five rights”—the right for the (1) right patient, (2) to receive the right medication, (3) in the right dose, (4) by the right route, (6) at the right time. For example, a medication error results when the wrong dose of a drug is administered to a patient. Medication errors also occur in numerous other circumstances that may or may not be related to one or more of the “five rights”. For example, if two medications look-alike or sound-alike, the wrong medication may be administered. In another example, a patient not connected to a ventilator or heart-rate monitor may be administered a medication that requires that the patient be connected to a ventilator or heart rate monitor. The end result of such medication errors ranges from no injury to the death of the patient.

Traditional approaches to preventing medication errors merely provide for the person administering a medication to attempt to prevent a violation of the basic “five rights”. For example, prior art systems may have guidelines that, if followed, attempt to ensure that a medication intended for one patient is not given to another non-intended patient (which would violate the patient's right for the (1) right patient (2) to receive the right medication). However, many errors, including lethal errors, have occurred in situations where practitioners firmly believed they had verified the “five rights.”Additionally, the prior art approaches do not conduct any further checks or comparisons beyond the basic “five rights” checking. For example, there is no mechanism to notify a nurse if a medication is being administered that looks like or sounds like another medication. In another example, if a patient must be connected to a ventilator or heart rate monitor when a certain medication is administered, there is no mechanism to notify the nurse or prevent the administration of the medication if a patient is not connected to a ventilator or heart rate monitor.

Accordingly, the prior art fails to provide a mechanism for conducting numerous automated checks. Additionally, the prior art fails to provide a mechanism for conducting automated checks beyond the basic “five rights” at the point of medication administration. What is needed is the ability to automatically evaluate a medication about to be administered and warn or notify appropriate personnel prior to the administration of the medication.

### SUMMARY OF THE INVENTION

Medication errors are a significant cause of injury and death to patients every year. Prior art systems fail to stop or warn practitioners of potential medication errors at the time of medication administration. One or mote embodiments of the invention provide a method, apparatus, and system for preventing medication errors by providing warnings at the time of medication administration. A user/administrator of medication is identified to the system. The patient is then identified to the system. Once the patient is identified, a graphical user interface (GUI) listing available medications for that patient is displayed. The user selects a medication for administration from the GUI.

One or more compliance rules are associated with one or more medications. Each compliance rule provides the text for a comment or warning to be displayed upon the occurrence of a specified condition. The condition may be based on an attribute of the medication or patient such as the name of the medication, allergies of the patient, etc. If a condition is satisfied, the comment/warning in the compliance rule associated with the medication is displayed to the user. If the user opts to continue with the administration of the medication, the medication is added to a confirmation list where the user administers the medication and may enter additional information regarding the administration (e.g., time of administration, notes, etc.).

The compliance rules may be invoked to display a comment/warning regarding the traditional five patient rights—tight patient, right medication, right dose, right route and right time. Additionally, the compliance rules may be invoked to display a comment/warning regarding many additional causes of medication errors. Such rules may include look-alike medications, sound-alike medications, physical act requirements, dosage requirements, monitor/health equipment requirements, route requirements, dilution requirements, test requirements, and lethal/toxic substance warnings.

### BRIEF DESCRIPTION OF THE DRAWINGS

Referring now to the drawings in which like reference numbers represent corresponding parts throughout:

FIG. 1 schematically illustrates a hardware and software environment in accordance with one or mote embodiments of the invention;

FIG. 2 illustrates the utilization of the software product in accordance with one or more embodiments of the invention; and

FIG. 3 illustrates a scheduled medication GUI screen in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

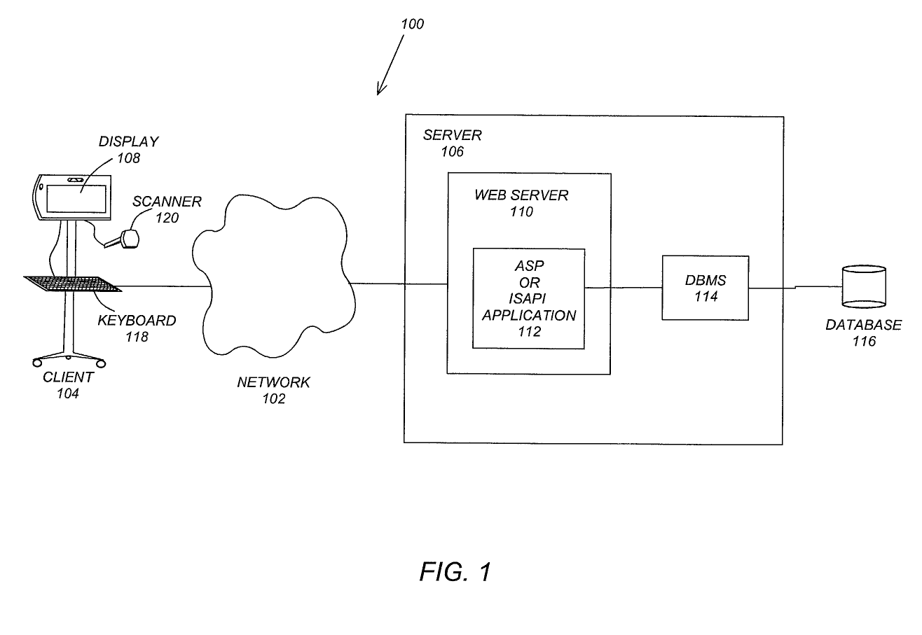

FIG. 1 schematically illustrates a hardware and software environment in accordance with one or more embodiments of the invention, and mote particularly, illustrates a typical distributed computer system 100 using a network 102 to connect client systems/computers 104 at a client 104 bedside to server computers 106. A typical combination of resources may include a network 102 comprising an intranet, the Internet, LANs, WANs, SNA networks, or the like, clients 104 operating/used at a client's 104 bedside that are personal computers, workstations, pen tablets, Windows CE devices, etc. (collectively referred to as computers), and servers 106 that are personal computers, workstations, minicomputers, mainframes, etc. Additionally, client 104 and server 106 may receive input using a touch pad display 108, keyboard 118, bar code scanner 120, cursor control device, or other input device.

In accordance with one or more embodiments of the invention, a network 102 such as the Internet or a hospital intranet connects clients 104 to server computers 106. Additionally, network 102 may utilize radio frequency (RF to connect and provide the communication between clients 104 and servers 106. Clients 104 may execute a client application or Web browsers on display 108 and communicate with server computers 106 executing Web servers 110. Such a Web browser is typically a program such as NETSCAPE NAVIGATOR or MICROSOFT INTERNET EXPLORER. Further, the software executing on clients 104 may be downloaded from server computer 106 to client computers 104 and installed as a plug in or ActiveX control of a Web browser. Accordingly, clients 104 may utilize ActiveX components/component object model (COM) or distributed COM (DCOM) components to provide a user interface or presentation layer on display 108. The Web server 110 is typically a program such as Microsoft's Internet Information Server. Thus, server 106 provides business logic to control a system of the invention and to communicate with client 104.

In one or more embodiments of the invention, web server 110 hosts an Active Server Page (ASP) or Internet Server Application Programming Interface (ISAPI) application 112, which may be executing scripts. The scripts invoke objects that execute business logic (referred to as business objects). The business objects then manipulate data in database 116 through a database management system DBMS) 114. When a developer encapsulates the business functionality into objects, the system may be referred to as a component object model (COM) system. Accordingly, the scripts executing on web server 110 (and/or application 112) invoke COM objects that implement the business logic. Further, server 106 may utilize Microsoft's Transaction Server (MTS) to access required data stored in database 116 via an interface such as ADO (Active Data Objects), OLE DB (Object Linking and Embedding DataBase), or ODBC (Open DataBase Connectivity).

Generally, these components 108-120 all comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

Software Embodiments

A software product used primarily by nurses and other healthcare professionals in a hospital setting may be utilized in accordance with embodiments of the invention. The software product enables hospitals to reduce medication errors by electronically verifying at the patient bedside, the “five rights” (tight patient, right drug, right dose, right route of administration, and right time) before the drug is administered to the patient. Additionally, the software product may provide for the electronic verification of the compliance/violation of multiple additional compliance rules maintained by the system or entered by a user. The compliance rules provide for the verification of medication administration well beyond the traditional “five rights”. The system also provides valuable and comprehensive medication information needed to continually improve the safety and quality of the hospital's medication management system and patient outcomes.

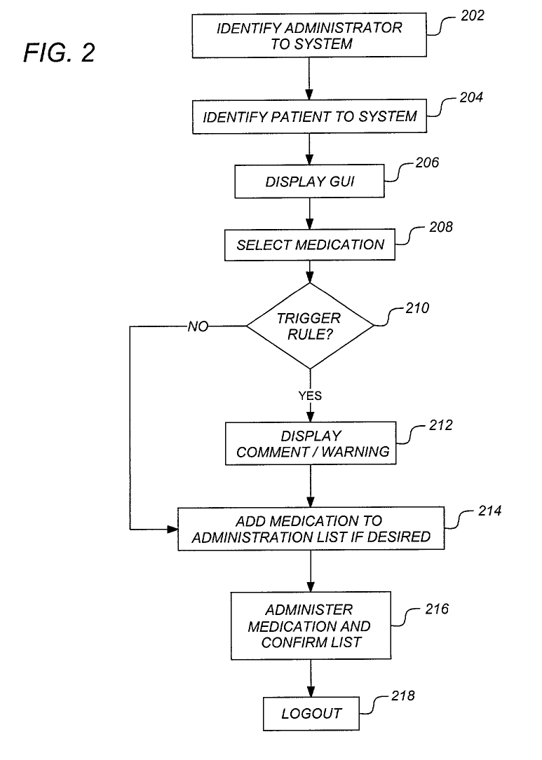

FIG. 2 illustrates the utilization of the software product in accordance with one or more embodiments of the invention. At step 202, an administrator such as a nurse is identified to the system. For example, a nurse may use scanner 120 to scan a bar code on the nurse's badge. At step 204, the patient is identified to the system. For example, the nurse may scan a patient's wristband using scanner 120. At step 206, the system displays a graphical user interface (GUI) on display 108. The GUI provides the user with an opportunity to view and select a desired medication that is scheduled and/or available for administration. Details of the GUI are described below.

At step 208, a medication is selected from the GUI. The selection of a medication indicates the user's intent to administer the selected medication. At step 210, a determination is made regarding whether or not the selected medication triggers or violates one or more compliance rules of the system. If a compliance rule is violated, an associated comment or warning is displayed at step 212. Details regarding specific types of rules, warnings, and comments are described below.

Once the user elects to administer a particular listed/scheduled medication at step 208, details of the medication are displayed to the user in a confirmation list at step 214. For example, when a nurse selects a particular prescription for administration, the route of the administration (e.g., IV) is displayed to the nurse. The detailed information allows the person administering the medication to confirm or delete one, some, or all of the medications as they are administered to the patient at step 216. A confirmation screen may present additional information such as the time the medication was administered, the name of the person administering the medication, and a co-signature (if required for the medication). Additionally, the confirmation or detailed medication screen may indicate the dose amount, dose unit, rate, route units, and route. At step 218, the user may log out the patient, the user, or both.

Graphical User Interface

The graphical user interface (GUI) provides for the display of relevant medication information in various formats and screens/areas. GUI display areas may include a components display and a medications display. The components display may include various tabs for listing the components, entering observations, and entering the administration of the component. The medications display may include a scheduled medications screen, a PRN screen, an IV screen, an all screen, a floorstock screen, and a formulary screen.

The medications on each screen may be displayed using three columns. The first column contains either a generic medication description or brand medication description depending on the user's selection. Column 2 comprises either the package size, package strength, or strength. Column 3 comprises the package description, dosage form, or an empty field. Using this three-columnar format, relevant consistent medication information that provides the ability to properly and completely identify the medication is displayed and utilized by the user. For any patient order, the medication displayed always provides the order give amount, the order give units, and the order display name (created using the final display medication description). Additionally, a pop-up window containing the entire medication description may be displayed when the display cursor is placed over any listed medication/order.

For component orders, a components tab/screen with each component and the amount of the component is provided. Component orders are orders wherein various components are added together to create a complete product. For example, a component order may call for the use of eight (8) different components to utilize in an intravenous solution (e.g., 600 mL Dextrose in Water, 400 mL Sterile Water, 250 mL Fat Emulsions 10%, 40 mEq KCI, 4.65 mEq CaGlucon, 8 mEq MagSulf, 10 mM Kphos, and NaPH).

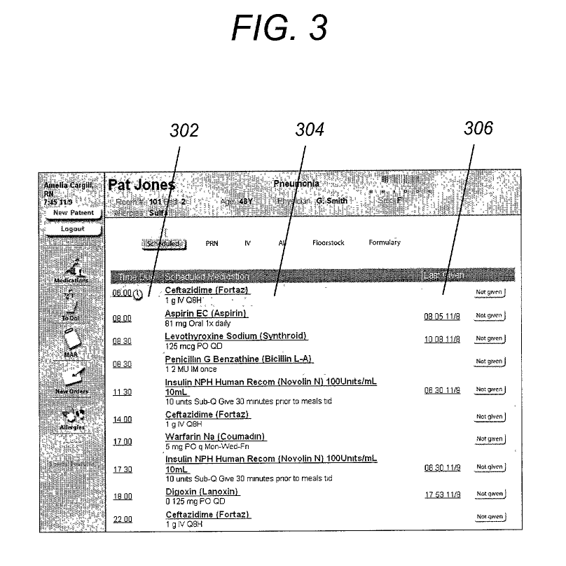

FIG. 3 illustrates a scheduled medication GUI screen in accordance with one or more embodiments of the invention. A scheduled medication list/screen identifies dose times/time due of the medication (using military time) 502, the name of the medication (using the consistent medication description) 504, and the last time the medication was administered (if any) 506. Additionally, the screen may indicate whether the scheduled medication is for a confirmed and active order and may provide a list of previously administered medications.

The PRN screen provides for medications that are pro re nata (given on demand). The PRN medication is listed with the consistent medication description followed by the last time the PRN medication was administered in a separate column. The PRN screen follows the same guidelines utilized for the scheduled medications screen.

The IV screen displays all of the IV medication orders for a given patient. The strength and rate for administering the medication intravenously also accompany each medication listed in the IV screen.

The all medications screen/list provides details on all patient orders and medications (IV, PRN, or otherwise) for a given patient. Each medication/patient order is listed with the appropriate strength, dosage, rate, etc. related information as provided on the other screens of the GUI. For example, the time the medication was last administered and the order state (e.g., active, on hold, future, expired, etc.) may be displayed adjacent to PRN and scheduled medications.

The Rootstock screen provides a listing of the patient orders/scheduled medications that are retrieved from the Rootstock where the patient is located. For example, Tylenol may be retrieved from the floorstock and administered to the patient.

The formulary screen provides a listing of the patient orders/scheduled medications that ate obtained/retrieved from the hospital's pharmacy. Such medications can include pain medications such as Morphine or tablets of antibiotics such as Keflex.

Compliance Rules

At step 210 of FIG. 2, the system determines if any selected medication violates a compliance rule. As described above, compliance rules check for compliance with the traditional five patient rights—right patient, right medication, right dose, right route of administration, and right time. The compliance rules may also check for compliance with many additional specified conditions provided by the system. A user such as a pharmacist, doctor, nurse, administrator, hospital, etc. may create compliance rules. Compliance rules may also be updated on a periodic basis as further medication errors or information is obtained (e.g., from the Institute of Safe Medication Practices, by scanning literature, by speaking with pharmacists and nurses, etc.). The compliance rules may be automatically updated into the system across network 102 or may be manually updated by a provider or user of the system.

When a compliance rule is violated, an associated comment or warning may be displayed to the user. The system may be configured to display all comments or warnings for all rule violations. However, to prevent a disruption in a nurse's workflow, the displaying of all of a medication's associated comments or warnings may by counterproductive. Accordingly, the system may be configured to only display comments or warnings that are designated as important or vital. For example, only compliance rule violations that may be lethal or result in the injury or death of the patient may be utilized. Further, a user may elect whether the comments/warnings associated with all rules, important rules, or user-specified rules should be displayed.

A compliance rule is comprised of a medication, a condition, and a comment/warning text. Thus, zero or more compliance rules may be associated with any single medication. The condition(s) that trigger or invoke the display of the comment/warning may be based on a medication's brand name, generic name, sequence number, dosage form, or other property. Accordingly, when the user selects a particular medication at step 208, the associated condition of the medication may be satisfied thereby causing the system to display the associated comments or warnings step 212. For example, if a condition for a compliance rule is based on a certain generic name, when the medication having the generic name is selected at step 208, the associated comment/warning is displayed at step 212. Additionally, the condition may be a combination of the above properties with a patient's data. For example, such a combination condition results in the display of a comment when a patient's allergies have an adverse reaction to the selected medication. In another example, the combination condition results in the display of a comment when a patient's current medical condition has an adverse reaction to the selected medication.

The associated comment/warning may emphasize certain text of a comment or warning (e.g., in capital, bold, italic, underscore, etc.). The emphasis may be utilized to bring attention to an aspect of the medication that gave rise to the warning itself (e.g., a particular syllable of two similar medications, the word MAXIMUM in a dosage rule, etc.).

The comment/warning may also provide some background information on the use of the medication. By providing background information, the person administering the medication is given the opportunity to double-check the medication and prescription. Background information can include a physical description of the medication, the common use of the medication, the symptom, disease or sickness the medication is used to treat, etc.

For example, suppose that confusion between two different medications results in the entry of the wrong medication for a patient into the computer system. A compliance rule that provides background information for the two medications results in the display of the comment/warning when a nurse selects the medication for administration. The background information will likely cause the nurse to stop and question the administration of the medication. For example, if a nurse is administering a medication to a patient for a skin rash, and a warning informs the nurse that the selected medication is for treating a neurological disorder, the nurse may stop and question the administration of the medication thereby preventing a medication error.

In accordance with one or more embodiments of the invention, compliance rules may fall into one or more of the following general categories:

(1) Look Alike;

(2) Sound Alike;

(3) Physical Acts Requirement;

(4) Dosage Requirement;

(5) Monitor/Health Equipment Requirement;

(6) Route Requirement;

(7) Dilution Requirement;

(8) Lethal/Toxic Substance Warning; and

(9) Tests Requirement.

Compliance rules from each of the above general categories assist in the prevention of medication errors.

Look Alike

Look alike compliance rules determine if the selected medication is similar in appearance to another medication. Severe consequences may result if a medication that looks similar to a selected medication is administered instead of the selected medication. For example, if a given medication X for treating hypertension is a capsule that is half red and half white, a look alike compliance rule associated with medication X may provide for displaying the following comment/warning: “Medication X can be confused with medication Y, Medication X is a red and white CAPSULE used to treat hypertension, medication Y is a red and white CAPSULE used for pain relief in musculoskeletal disorders.”

Sound Alike

Sound alike compliance rules determine if the selected medication is acoustically similar to another medication. Two types of sound alike compliance rules may be utilized: (1) typical and (2) extra verification needed.

Typical sound alike compliance rules provide a warning that the selected medication may be confused with another medication and provide a brief explanation for the use of the medication. The format for such a warning is “Medication X can be confused with Medication Y; Medication X is an _____ used to treat ______, Medication Y is used to treat ______.” Variations of the format may also be utilized. For example, only the phrase “used to treat ______” may be utilized and the phrase “is an _____” may not be utilized. Alternatively, the “used to treat” phrase may be replaced with “used for”.

For example, in a typical sound alike compliance rule, if the user selects a medication with the generic name Naloxone HCI (brand name Narcan), the following comment/warning may be displayed:

“NARcan can be confused with NORcuron; Narcan is a narcotic antagonist, Norcuron is a neuromuscular blocker used in anesthesia.” A narcotic antagonist is an agent that inhibits the effect of narcotics on the central nervous system. Narcan is FDA approved for the treatment of opiate overdose, diagnosis of opioid tolerance, and reversal of postoperative opiate depression. A neuromuscular blocker interrupts the transmission of nerve impulses and may be used in association with anesthesia to increase effectiveness, improve delivery, or decrease required dosage. Accordingly, if the patient is not being treated for an opiate overdose, does not need a narcotic antagonist, or is in surgery where anesthesia is being utilized, the nurse will read the warning and stop and question whether or not to administer Narcan.

Some examples of the comments/warnings of other typical sound alike compliance rules are:

“PreCOSE can be confused with PreCARE; Precose is used to treat Type II Diabetes, PreCare is a prenatal vitamin”;

“ISOtretinoin can be confused with TRETinoin; Isotretinoin is an ORAL agent used to treat acne and other skin disorders, Tretinoin is a TOPICAL agent which is also used to treat acne and skin disorders”;

“NORVasc can be confused with NAVane; Norvasc is used to treat hypertension and angina, Narvane is used to treat psychotic disorders”; and

“AmIODARone can be confused with atnRINone; Amiodarone is used to treat arrhythmias and angina, Amrinone is used for CHF.”

The second type of sound alike compliance rule provides for a comment/warning indicating that some form of extra verification should be performed by the user prior to administering the medication.

In one such compliance rule, the comment/warning indicates that the user should verify the name and dosage if the dose exceeds a specified amount. For example, the following warning may be displayed: “AMPHOTERICIN B can be confused with Amphotericin B LIPID COMPLEX; Verify medication name and dosage if dose is greater than 1.5 mg/kg, Amphotericin B is a bright yellow color.”

In another sound alike verification type compliance rule, the comment/warning indicates that the user should ensure that the correct type of medication is being selected. For example, the following warning may be displayed: “You have selected insulin. Please verify that you have the correct type.”

In yet another sound alike verification type compliance rule, the comment/warning indicates that the user should verify that the correct pre-mixed bag is being utilized. For example, the following warning may be displayed when Lidocaine HCI/D5W is selected for administration: “Make sure you have the correct pre-mixed bag. Lidocaine is used as an antiarrhythmic”. In another example, the following warning may be displayed when Theophylline/D5W is selected for administration: “Double check that you have the correct pre-mixed bag. Theophyline is used to treat asthma.”

Physical Acts Requirement

Physical Acts requirement compliance rules are associated with a comment/warning indicating that certain physical acts by the patient ate required. Such acts may include the consumption of the medication with food or water or the avoidance of certain physical activities prior or subsequent to medication administration.

For example, a physical acts requirement rule may specify that food/water must or should be consumed within or outside of a specified time period from medication administration accompanied by a lack of a specified physical activity as follows: “Give with a large glass of water at least 30 minutes prior to a meal; Patient should be instructed to AVOID LYING DOWN for at least 30 minutes following administration of Alendronate sodium (Fosamax)”.

In another example, the following physical requirement compliance rules indicate that a patient must eat within a designated time period following medication administration:

“Make sure your patient eats within 30-45 minutes of administration of Humulin”; and

“Make sure your patient eats within 10 minutes of administration of Humalog”.

Dosage Requirement

Dosage requirement compliance rules are associated with a warning/comment relating to medication dosages. Traditionally, systems merely check for a single maximum dosage. Dosage requirement compliance rules in accordance with embodiments of the invention may provide rules for a maximum dosage over a specified time period (e.g., hour, day, week, etc.) or require a specified time period between doses. For example, a comment/warning of a dosage requirement compliance rule may indicate that doses should be administered a specified time period apart as follows: “Give doses at least 10 minutes apart; Midazolam is used for pre-op sedation and light anesthesia.”

Monitor/Health Equipment Requirement

Monitor/health equipment requirement compliance rules contain a warning/comment indicating that a patient must be connected to a monitor or other type of health equipment. Two essential types of rules exist in this category: Ventilator Required and Heart Monitor Required.

When certain medications are administered, a patient must be connected to a ventilator. Accordingly, compliance rules associated with such medications display a warning that the patient must be connected to a ventilator. For example, the following compliance rule warnings indicate a ventilator requirement:

“Your patient MUST BE ON A VENTILATOR when receiving this medication!! Actracurium besylate (Tracrium) is a neuromuscular blocker used in anesthesia”; and

“Your patient MUST BE ON A VENTILATOR when receiving this medication!! Mivacurium is a neuromuscular blocker used in anesthesia”;

Further, when certain medications are administered, the patient must be connected to a heart monitor. For example, the following compliance rule warnings indicate that a heart monitor is required:

“A HEART MONITOR must be in place when administering this medication; DO NOT GIVE WITH IV BETA-BLOCKERS; Ephinephrine is used as a bronchodilator and for anaphylaxis”;

“A HEART MONITOR must be in place when administering this medication; DO NOT GIVE WITH IV BETA-BLOCKERS; Isoproterenol is used to treat cardiac arrhythmias and shock”; and

“A HEART MONITOR must be in place when administering this medication; DO NOT GIVE WITH IV BETA-BLOCKERS; Norepinephrine is used to treat hypotension and shock”.

Route Requirement

Route requirement compliance rules have an associated comment/warning that a particular medication must be administered via a certain route (e.g., intravenously, orally, intramuscularly, etc.). For example, the following comments from route requirement compliance rules demonstrate medication administration through a specific route:

“Calcium Chloride is for IV ADMINISTRATION ONLY. Avoid extravasation”;

“Administer INTRAVENOUSLY ONLY!! Fatal if given intrathecally. Vincristine is a chemotherapeutic agent”;

“For ORAL ADMINISTRATION ONLY!! Do not inject contents of capsule. Nimotop is used for subarachnoid bleeding”; and

“For INTRAMUSCULAR (IM) injection only!!”.

Dilution Requirement

Dilution requirement compliance rules are associated with comments indicating that the medication must be diluted prior to administration. For example, the following comments/warnings are associated with dilution requirement compliance rules:

“You have selected esmolol (Brevibloc) concentrate (250 g/l mL). This product MUST BE DILUTED PRIOR TO ADMINISTRATION!! Esmolol is used for acute management of tachycardia and hypertension”; and

“DILUTE potassium chloride before IV administration. Avoid extravasation.”

Lethal/Toxic Substance Warning

Lethal/toxic warning compliance rules are associated with a warning that indicates that a particular medication or dosage of a medication is lethal or contains a toxic substance. For example the following warning may be displayed when Methylprednisolone acetate is selected: “Warning: 5 mL vials contain the preservative benzyl alcohol, which is neurotoxic!”

Tests Requirement

Tests requirement compliance rules ate associated with a comment or warning indicating that a test should have/must be performed prior to medication administration. Alternatively, a tests requirement compliance rule may pose a query to the user asking if a specific test has been performed within a given time period. For example, the following query may be posed to a user upon the selection of Digoxin: “Has a digoxin level been drawn within the last 72 hours?” Embodiments of the invention may allow the user to input a response that is recorded. Alternatively, the question may merely be displayed and may be bypassed by the user selecting “cancel” or “ok”.

Conclusion

This concludes the description of one or more embodiments of the invention. The following describes some alternative embodiments for accomplishing the present invention. For example, any type of computer, such as a mainframe, minicomputer, pen tablet, CE device, or personal computer, or computer configuration, such as a timesharing mainframe, local area network, or standalone personal computer, could be used with the present invention. In summary, embodiments of the invention provide the ability to consistently display access, and utilize medication information including medication descriptions.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A computer programmed method for providing medication administration comments comprising:
accepting a medication administrator identification for a medication administrator;
accepting a patient identification for a patient from the medication administrator;
displaying a graphical user interface listing one or more medications scheduled for administration to the patient;
accepting the selection of one of the listed medications;
determining if a condition for a compliance rule has been satisfied, wherein the compliance rule relates to the selected medication and has an associated comment; and
displaying, on a display device, the comment associated with the compliance rule when the condition has been satisfied.

2. The method of claim 1 wherein the condition is satisfied when a generic name for a medication matches the selected medication.

3. The method of claim 1 wherein the condition is satisfied when a brand name for a medication matches the selected medication.

4. The method of claim 1 wherein the comment indicates that the selected medication is similar in appearance to another medication.

5. The method of claim 1 wherein the comment indicates that the selected medication is acoustically similar to another medication.

6. The method of claim 1 wherein the comment indicates additional verification of an aspect of the medication should be performed.

7. The method of claim 1 wherein the comment indicates that the medication should be taken within a specified time period of food consumption.

8. The method of claim 1 wherein the comment indicates that the medication should be taken within a specified time period of drinking water.

9. The method of claim 1 wherein the comment indicates that the patient should perform certain physical acts within a specified time period of administration of the medication.

10. The method of claim 1 wherein the comment indicates that dosages of the medication should be administered a specified time period apart.

11. The method of claim 1 wherein the comment warns that the patient must be connected to a ventilator when the medication is administered.

12. The method of claim 1 wherein the comment warns that the patient must be connected to a heart monitor when the medication is administered.

13. The method of claim 1 wherein the comment indicates that the medication should be administered by a certain route.

14. The method of claim 1 wherein the comment indicates that the medication should be diluted prior to administration.

15. The method of claim 1 wherein the comment indicates that the medication contains a toxic substance.

16. The method of claim 1 wherein the comment indicates that certain tests should be performed.

17. The method of claim 1 wherein the comment provides background information relating to the medication.

18. A system for providing medication administration comments comprising:
(a) a computer having a memory and a processor;
(b) a compliance rule stored in said memory, wherein the compliance rule is associated with a medication and maintains a condition and a comment relating to the medication;
(c) a program executing on said computer, the program configured to:
(1) accept a medication administration identification for a medication administrator;
(2) accept a patient identification for a patient from the medication administrator;
(3) accept a selection of a listed medication;
(4) determine if the condition for the compliance rule has been satisfied;
(d) a graphical user interface (GUI) executing on said computer, the graphical user interface configured to:
(1) list one or more medications scheduled for administration to the patient;
(2) display the comment associated with the selected medication from the compliance rule when the program determines that the condition for the compliance rule has been satisfied.

19. The system of claim 18 wherein the condition is satisfied when a generic name for a medication matches the selected medication.

20. The system of claim 18 wherein the condition is satisfied when a brand name for a medication matches the selected medication.

21. The system of claim 18 wherein the comment indicates that the selected medication is similar in appearance to another medication.

22. The system of claim 18 wherein the comment indicates that the selected medication is acoustically similar to another medication.

23. The system of claim 18 wherein the comment indicates additional verification of an aspect of the medication should be performed.

24. The system of claim 18 wherein the comment indicates that the medication should be taken within a specified time period of food consumption.

25. The system of claim 18 wherein the comment indicates that the medication should be taken within a specified time period of drinking water.

26. The system of claim 18 wherein the comment indicates that the patient should perform certain physical acts within a specified time period of administration of the medication.

27. The system of claim 18 wherein the comment indicates that dosages of the medication should be administered a specified time period apart.

28. The system of claim 18 wherein the comment warns that the patient must be connected to a ventilator when the medication is administered.

29. The system of claim 18 wherein the comment warns that the patient must be connected to a heart monitor when the medication is administered.

30. The system of claim 18 wherein the comment indicates that the medication should be administered by a certain route.

31. The system of claim 18 wherein the comment indicates that the medication should be diluted prior to administration.

32. The system of claim 18 wherein the comment indicates that the medication contains a toxic substance.

33. The system of claim 18 wherein the comment indicates that certain tests should be performed.

34. The system of claim 18 wherein the comment provides background information relating to the medication.

35. An article of manufacture comprising a program storage medium readable by a computer and embodying one or more instructions executable by the computer to perform a method for providing medication administration comments, the method comprising:
accepting a medication administrator identification for a medication administrator;
accepting a patient identification for a patient from the medication administrator;
displaying a graphical user interface listing one or more medications scheduled for administration to the patient;
accepting the selection of one of the listed medications;
determining if a condition for a compliance rule has been satisfied, wherein the compliance rule relates to the selected medication and has an associated comment; and
displaying, on a display device, the comment associated with the compliance rule when the condition has been satisfied.

36. The article of manufacture of claim 35 wherein the condition is satisfied when a generic name for a medication matches the selected medication.

37. The article of manufacture of claim 35 wherein the condition is satisfied when a brand name for a medication matches the selected medication.

38. The article of manufacture of claim 35 wherein the comment indicates that the selected medication is similar in appearance to another medication.

39. The article of manufacture of claim 35 wherein the comment indicates that the selected medication is acoustically similar to another medication.

40. The article of manufacture of claim 35 wherein the comment indicates additional verification of an aspect of the medication should be performed.

41. The article of manufacture of claim 35 wherein the comment indicates that the medication should be taken within a specified time period of food consumption.

42. The article of manufacture of claim 35 wherein the comment indicates that the medication should be taken within a specified time period of drinking water.

43. The article of manufacture of claim 35 wherein the comment indicates that the patient should perform certain physical acts within a specified time period of administration of the medication.

44. The article of manufacture of claim 35 wherein the comment indicates that dosages of the medication should be administered a specified time period apart.

45. The article of manufacture of claim 35 wherein the comment warns that the patient must be connected to a ventilator when the medication is administered.

46. The article of manufacture of claim 35 wherein the comment warns that the patient must be connected to a heart monitor when the medication is administered.

47. The article of manufacture of claim 35 wherein the comment indicates that the medication should be administered by a certain route.

48. The article of manufacture of claim 35 wherein the comment indicates that the medication should be diluted prior to administration.

49. The article of manufacture of claim 35 wherein the comment indicates that the medication contains a toxic substance.

50. The article of manufacture of claim 35 wherein the comment indicates that certain tests should be performed.

51. The article of manufacture of claim 35 wherein the comment provides background information relating to the medication.
